(19) United States
(12) Patent Application Publication
(10) Pub. No.: US 2024/0017361 A1
(43) Pub. Date: Jan. 18, 2024

(54) WELDING PRESS HEAD TOOL AND WELDING DEVICE

(71) Applicant: Contemporary Amperex Technology Co., Limited, Ningde City (CN)

(72) Inventors: Tianxiang QUE, Ningde City (CN); Xiang FAN, Ningde City (CN); Gang LIN, Ningde City (CN); Qingsong XIE, Ningde City (CN)

(21) Appl. No.: 18/213,734

(22) Filed: Jun. 23, 2023

(30) Foreign Application Priority Data
Jul. 13, 2022 (CN) 202221791529.6

(51) Int. Cl. B23K 37/04

(52) U.S. Cl. CPC B23K 37/04; H01M 10/0404

(57) ABSTRACT

The present application relates to a welding press head tool and a welding device. The welding press head tool includes at least one press head assembly, each including: a press plate provided with a first through hole penetrating the press plate in a first direction; a press head movably connected to one side of the press plate in the first direction and capable of having a first gap with the press plate when the press head moves relative to the press plate, where the press head has a second through hole penetrating the press head in the first direction, and the first through hole and the second through hole are in communication to jointly define a welding channel for providing a welding space; and at least two groups of blocking assemblies arranged between the press plate and the press head.

### CROSS-REFERENCE TO RELATED APPLICATION

This application claims priority to Chinese Patent Application No. 202221791529.6, entitled “WELDING PRESS HEAD TOOL AND WELDING DEVICE” filed on Jul. 13, 2022, which is incorporated herein by reference in its entirety.

### TECHNICAL FIELD

The present application relates to the technical field of welding, and in particular to a welding press head tool and a welding device.

### BACKGROUND ART

During production and manufacturing of batteries, welding has been an important constituent part in a production process of products. With regard to a welding device in the related art, a component to be welded on a battery cell is generally fixed by means of a welding press head, and a welding operation is performed in a welding channel arranged on the welding press head. In a specific implementation, the welding press head may include a press plate and a press nozzle movably connected to one side of the press plate, and the press nozzle is capable of pressing the component to be welded on a clamp. However, during welding, high-temperature welding slag or the like generated in the welding channel may be splashed out through a gap between the press plate and the press nozzle, thereby affecting other non-welding parts on the battery cell and increasing the maintenance cost of the welding device.

### SUMMARY

On this basis, it is necessary to provide a welding press head tool and a welding device for solving the problem that welding slag is likely to be splashed to the outside of a tool during welding of a welding press head tool in the related art.

According to a first aspect of the present application, provided is a welding press head tool, including at least one press head assembly. Each press head assembly includes: a press plate provided with a first through hole penetrating the press plate in a first direction; a press head movably connected to one side of the press plate in the first direction and capable of having a first gap with the press plate when the press head moves relative to the press plate, where the press head has a second through hole penetrating the press head in the first direction, and the first through hole and the second through hole are in communication to jointly define a welding channel for providing a welding space; and at least two groups of blocking assemblies arranged between the press plate and the press head, where each blocking assembly is used for blocking a channel formed by the first gap in a second direction perpendicular to the first direction, and at least two groups of blocking assemblies in all the blocking assemblies are arranged spaced apart in a radial direction of the welding channel and have overlapping portions in a circumferential direction of the welding channel.

There is the first gap between the press plate and the press head, such that the channel (hereinafter also referred to as an escape channel) for welding slag and laser light to escape is formed in the second direction perpendicular to the first direction, in other words, the welding slag in the welding channel is radially spread or splashed to the outside of the welding press head tool through the escape channel in the radial direction of the welding channel. In the above-described solution, the channel formed in the first gap in the second direction may be blocked by arranging at least two groups of blocking assemblies between the press plate and the press head. In addition, the at least two groups of blocking assemblies are arranged spaced apart in the radial direction of the welding channel and have the overlapping portions in the circumferential direction of the welding channel, and the overlapping portion in the circumferential direction enables this region in the circumferential direction to have at least two barriers to block the splashed welding slag, effectively preventing the welding slag from being splashed to other non-welding parts on a battery cell, and reducing the maintenance cost of a welding device.

In one of embodiments, each blocking assembly includes a blocking bar, and the blocking bar is arranged on one of the press plate and the press head and extends out toward the other. By arranging the strip-shaped blocking bars, on the one hand, machining is facilitated, and on the other hand, the blocking bars can block the escape channel formed in the first gap in a length direction thereof and have a good blocking effect.

In one of the embodiments, among the blocking assemblies arranged spaced apart in the radial direction of the welding channel and having the overlapping portions in the circumferential direction of the welding channel, at least one group of blocking assemblies is located at an outer contour edge of the press head, and at least one group of blocking assemblies is located between the outer contour edge of the press head and an orifice edge of the second through hole.

According to arrangement positions of the blocking assemblies, at least one group of blocking assemblies is located at the outer contour edge of the press head, and can block the splashed welding slag at an outermost side of the press head, and can also prevent dust and the like outside the welding press head from entering the welding press head; and at least one group of blocking assemblies is located between the outer contour edge of the press head and the orifice edge of the second through hole, and can form two blocking lines for the first gap, so that the blocking effect on the welding slag is better.

In one of embodiments, the blocking assembly further includes an insert groove arranged corresponding to the blocking bar and used for inserting the blocking bar; and the blocking bar is arranged on one of the press plate and the press head, and the insert groove is formed in the other of the press plate and the press head.

By arranging the insert groove capable of accommodating the blocking bar, when the press head and the press plate are close to each other, an inserted bar on the press head can extend into the corresponding insert groove; on the one hand, surfaces of the press head and the press plate that are opposite to each other can continue to be close to each other, avoiding the phenomenon that the press head cannot continue to move due to the arrangement of the blocking bar; on the other hand, the at least two groups of blocking bars cooperate with the insert grooves to form a structure similar to a labyrinth seal, so that a path for the welding slag or dust to pass in and out of the welding channel becomes longer, and the blocking effect is better.

In one of the embodiments, in the same blocking assembly, the blocking bar is arranged on the surface of the press head facing the press plate, and the insert groove is formed in the surface of the press plate facing the press head.

During the use of the welding press head, the press plate needs to be connected to a rack of a welding apparatus, and the press head is movably connected to the press plate, making maintenance and replacement of the press head easier compared with the press plate. If the blocking bar structure is damaged or needs to be maintained or replaced in other cases, it is easier to arrange the blocking bar structure on the press head.

In one of the embodiments, in the blocking assembly located at the outer contour edge of the press head, an extension end of the blocking bar is provided with a hooking portion, and a limiting portion is arranged at a rabbet of the insert groove corresponding to the hooking portion; and the hooking portion extends into the insert groove, and the hooking portion is used for being hooked on the limiting portion when the blocking bar moves away from the insert groove. By means of the cooperation of the hooking portion and the limiting portion, a deviation movement of the press head relative to the press plate can be limited, that is to say, the phenomenon can be avoided that the press head disengages from the press plate, causing the blocking assembly to be incapable of blocking the first gap.

In one of the embodiments, among the blocking assemblies arranged spaced apart in the radial direction of the welding channel and having the overlapping portions in the circumferential direction of the welding channel, at least one group of blocking assemblies is located at the orifice edge of the second through hole. The blocking assembly being located at the orifice edge of the second through hole actually means that the welding slag is blocked at a juncture of the first gap and the second through hole, effectively preventing the welding slag from entering the first gap.

In one of the embodiments, in the blocking assembly located at the orifice edge of the second through hole, a blocking bar is arranged on the press head and extends out to an inner side of an inner wall of the first through hole. In this way, the blocking bar is capable of better blocking the first gap.

In one of the embodiments, a first recess and a second recess are respectively formed in the surfaces of the press plate and the press head opposite to each other, the first recess is in communication with the first through hole, the second recess is in communication with the second through hole, the first recess and the second recess correspond to each other in position and jointly define a dust removal channel in communication with the outside of the press head assembly, and in the blocking assembly located at the orifice edge of the second through hole, part of a structure of the blocking bar extends into an inner side of an inner wall of the first recess and extends in an axial direction of the dust removal channel.

In the above-described solution, one end of the dust removal channel is in communication with the welding channel, and the other end may be connected to a negative pressure apparatus, such that the welding slag generated in the welding channel can be removed through the dust removal channel. The dust removal channel is formed by combining the first recess and the second recess, and the blocking bar in the blocking assembly extends into the inner side of the inner wall of the first recess and extends in the axial direction of the dust removal channel, so that the blocking bar can better block the first gap.

In one of the embodiments, a third recess and a fourth recess are respectively formed in the surfaces of the press plate and the press head opposite to each other, the third recess is in communication with the first through hole, the fourth recess is in communication with the second through hole, the third recess and the fourth recess correspond to each other in position and jointly define a gas intake channel in communication with the outside of the press head assembly, and in the blocking assembly located at the orifice edge of the second through hole, the blocking bar extends into an inner side of an inner wall of the third recess and extends in an axial direction of the gas intake channel. In this way, the blocking bar is capable of better blocking the first gap.

In one of the embodiments, six groups of blocking assemblies are provided, where three groups of blocking assemblies are located on a first side of the welding channel, are arranged spaced apart in the radial direction of the welding channel, and have overlapping portions in the circumferential direction of the welding channel; the other three groups of blocking assemblies are located on a second side of the welding channel, are arranged spaced apart in the radial direction of the welding channel, and have overlapping portions in the circumferential direction of the welding channel; where the first side and the second side are opposite sides of the welding channel in the radial direction thereof. As described above, the welding slag is blocked and covered at the two opposite sides of the welding channel, so that the welding slag can be prevented from being splashed out of the welding channel from two directions of the opposite sides of the welding channel.

In one of the embodiments, the blocking bars in each blocking assembly extend in the second direction; where the second direction is perpendicular to a direction from the first side to the second side and perpendicular to the first direction. In this way, the entire first gap can be blocked and covered as much as possible.

In one of the embodiments, at least two groups of press head assemblies are provided, and the press plates in the at least two groups of press head assemblies are interconnected or integrally formed; and the press heads in the at least two groups of press head assemblies are located on the same side of the corresponding press plates and are arranged spaced apart from each other. By interconnecting or integrally forming the press plates in at least two groups of press head assemblies as described above, the structure of the welding press head tool can be more compact.

In one of the embodiments, the press head assembly further includes a connecting rod, the connecting rod is movably connected to the press plate in the first direction, and an end portion of the connecting rod facing the press head is detachably connected to the press head. The press head is connected to the connecting rod, and the connecting rod is movably connected to the press plate, such that when the connecting rod moves relative to the press plate, the press head can be driven to move relative to the press plate.

According to a second aspect of the present application, provided is a welding device, the welding device including a welding press head tool of the foregoing embodiment.

In one of the embodiments, the welding device further includes: a rack to which a welding press head tool is connected; a clamp that is used for clamping and fixing a component to be welded and is arranged opposite to the welding press head tool; a jacking mechanism that is arranged on the rack, is connected to the clamp and is used for driving the component to be welded on the clamp to move in an opposite direction of the welding press head tool and the clamp; and a limiting mechanism that is arranged on the rack, is used for limiting, when the clamp is located in a first preset position relative to the welding press head tool, a displacement of the clamp toward the welding press head tool.

In the above-described solution, a lower reference position of a welding operation is limited by arranging a limiting mechanism, so as to eliminate the instability of such a clamping force. Specifically, the limiting mechanism is used for limiting, when the clamp is located in the first preset position relative to the welding press head tool, the displacement of the clamp toward the welding press head tool, namely, the jacking mechanism can drive the clamp to reach the same position each time, in other words, during welding each time, the component to be welded on the welding clamp can be located in the same position in a height direction. In this way, the component to be welded has the same position lower reference in different welding processes, so that the problem can be solved that the clamping force is unstable due to fluctuations in the relative positions of the welding press head and the clamp, and the welding quality is improved.

In one of the embodiments, the limiting mechanism includes a moving member and a limiting baffle, and the moving member is connected to the clamp; the limiting baffle is connected to the rack, and the limiting baffle is located on a movement path of the moving member; and when the moving member moves to abut against the limiting baffle under the drive of the clamp, the clamp is located in the first preset position relative to the welding press head tool. In the above-described solution, the moving member can be in linkage with the clamp, and a position of the moving member is limited by means of the limiting baffle, so that the position of the clamp is limited. The structure is simple and easy to operate.

In one of the embodiments, the press plate and the press head are movably connected by means of the connecting rod, an elastic member is arranged between the press plate and the press head, and the elastic member is used for applying to the press head an elastic force facing away from the press plate; and the first gap between the press plate and the press head is greater than or equal to 2 mm. Thus, the elastic member is enabled to offset a dimensional chain tolerance of the component to be welded. Even for different tolerances of components to be welded, the components to be welded can also be subjected to the same pressure.

In one of the embodiments, the elastic member has an elastic coefficient of 5.6 N/mm. Thus, a pressing force of the welding press head tool acting on the component to be welded is less than or equal to 150 N.

### BRIEF DESCRIPTION OF THE DRAWINGS

FIG. 1 is a schematic structural diagram of a welding press head tool according to an embodiment of the present application;

FIG. 2 is a schematic exploded structural diagram of a welding press head tool according to an embodiment of the present application;

FIG. 3 is a schematic structural diagram, from another perspective, of the welding press head tool according to an embodiment of the present application;

FIG. 4 is a partially enlarged view of part A in FIG. 3;

FIG. 5 is a top view of a press head in a welding press head tool according to an embodiment of the present application;

FIG. 6 is a schematic exploded structural diagram, from another perspective, of the welding press head tool according to an embodiment of the present application;

FIG. 7 is a cross-sectional view of a welding press head tool according to an embodiment of the present application;

FIG. 8 is a schematic structural diagram of a welding device according to an embodiment of the present application; and

FIG. 9 is a schematic diagram of an operating principle of a welding device according to an embodiment of the present application.

### LIST OF REFERENCE NUMERALS

100. Press head assembly; 101. First gap; 110. Press plate; 111. Guide hole; 1111. Counter bored hole; 120. First through hole; 130. Press head; 140. Connecting rod; 141. Elastic member; 150. Second through hole; 151. Orifice edge of second through hole;
160. Blocking assembly; 160a. First blocking assembly; 160b. Second blocking assembly; 160c. Third blocking assembly; 161. Blocking bar; 1611. Hooking portion; 162. Insert groove; 1621. Limiting portion;
170. Welding channel; 180. Dust removal channel; 181. First recess; 182. Second recess; 190. Gas intake channel; 191. Third recess; 192. Fourth recess;
200. Welding press head tool;
300. Welding device; 310. Rack; 311. Limiting baffle; 320. Clamp; 330. Component to be welded;
340. Jacking mechanism; 350. Limiting mechanism; 351. Moving member.

### DETAILED DESCRIPTION OF EMBODIMENTS

In order to make the above objectives, features and advantages of the present application more clearly understood, particular embodiments of the present application will be described in detail below with reference to the accompanying drawings. In the following description, numerous specific details are set forth in order to provide a thorough understanding of the present application. However, the present application can be implemented in many other ways different from those described herein, and those skilled in the art can make similar improvements without departing from the essence of the present application. Therefore, the present application is not limited by the particular embodiments disclosed below.

In the description of the present application, it should be understood that the orientation or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential”, etc. are based on the orientation or positional relationships shown in the accompanying drawings and are merely for ease of description of the present application and simplification of the description, rather than indicating or implying that the devices or elements referred to must have a specific orientation or be constructed and operated in a described orientation, and therefore cannot be construed as limiting the present application.

In addition, the terms “first” and “second” are used for descriptive purposes only, and cannot be construed as indicating or implying relative importance or implicitly indicating the number of technical features indicated. Therefore, the features defined with “first” and “second” may explicitly or implicitly include at least one of the features. In the description of the present application, the meaning of “a plurality of” is at least two, such as two, three and so on, unless otherwise specifically defined.

In the present application, unless expressly stated or limited otherwise, the terms such as “mounting”, “connection”, “connected” and “fixing” should be interpreted broadly, for example, either fixed or detachable connection, or integration; or may be a mechanical connection or an electrical connection; or may be a direct connection or an indirect connection through an intermediate medium, or may be communication between interiors of two elements or interaction between two elements, unless it may be clearly defined otherwise. For those of ordinary skills in the art, the specific meaning of the foregoing terms in the present application may be understood according to specific circumstances.

In the present application, unless otherwise explicitly specified and defined, the expression of a first feature being “on” or “under” a second feature may be the case that the first feature is in direct contact with the second feature, or the first feature is in indirect contact with the second feature via an intermediate medium. Furthermore, the expression of the first feature being “over”, “above” and “on top of” the second feature may be the case that the first feature is directly above or obliquely above the second feature, or only means that the level of the first feature is higher than the second feature. The expression of the first feature being “underneath”, “below” and “beneath” the second feature may be the case that the first feature is directly below or obliquely below the second feature, or only means that the level of the first feature is less than the second feature.

It should be noted that when an element is referred to as being “fixed to” or “arranged on” another element, it may be directly on the other element or an intervening element may be present. When an element is referred to as being “connected” to another element, it may be directly connected to the other element or an intervening element may be present. The terms “vertical”, “horizontal”, “upper”, “lower”, “left”, “right” and similar expressions used herein are for the purpose of illustration only and do not represent any unique embodiment.

During production and manufacturing of batteries, welding has been an important constituent part in a production process of products. With regard to a welding device in the related art, a component to be welded on a battery cell is generally fixed by means of a welding press head, and a welding operation is performed in a welding channel arranged on the welding press head.

In a specific implementation, the welding press head may include a press plate and a press nozzle movably connected to one side of the press plate, and the press nozzle is capable of pressing the component to be welded on a clamp. During welding, high-temperature welding slag or the like generated in the welding channel may be typically splashed out of the welding channel, thereby affecting other non-welding parts on the battery cell and increasing the maintenance cost of the welding device.

The applicant of the present application found after research that in the welding press head of the related art, the phenomenon often occurs that the high-temperature welding slag in the welding channel is splashed out from the press plate and the press nozzle of the welding press head, because a certain gap is generally reserved between the press plate and the press nozzle; when the welding device is a laser welding device, not only the welding slag is splashed, but also laser light harmful to the human body is leaked out from the gap, affecting other non-welding parts of the battery cell, and also seriously affecting personal safety of an operator.

In order to solve the problem of welding slag splashing during the use of the conventional welding press head, the applicant of the present application designed, after an intensive research, a welding press head tool and a welding device, where two or more groups of blocking assemblies are arranged in a gap between a press plate and a press head, and at least part of a region has two or more blocking barriers in a slag flyout direction (or a laser radiation direction), so that a blocking effect on the welding slag is better.

The welding devices to which the welding press head tool disclosed in the embodiments of the present application is applied include, but are not limited to, various types of welding devices such as laser welding devices, ultrasonic welding devices, resistance welding devices, high-frequency induction welding devices, etc. A variety of components to be welded may also be welded, for example, welding of a busbar and a post, welding of an adapter piece and a post, etc.

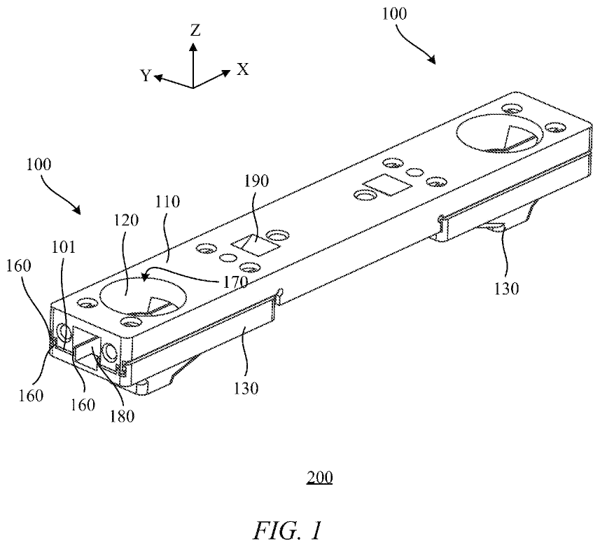

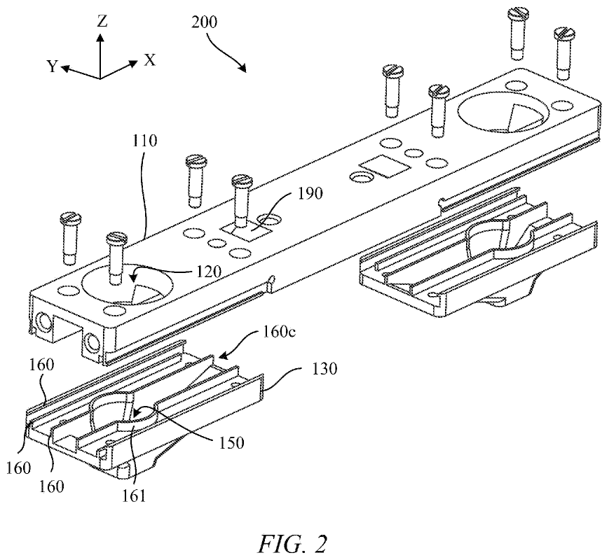

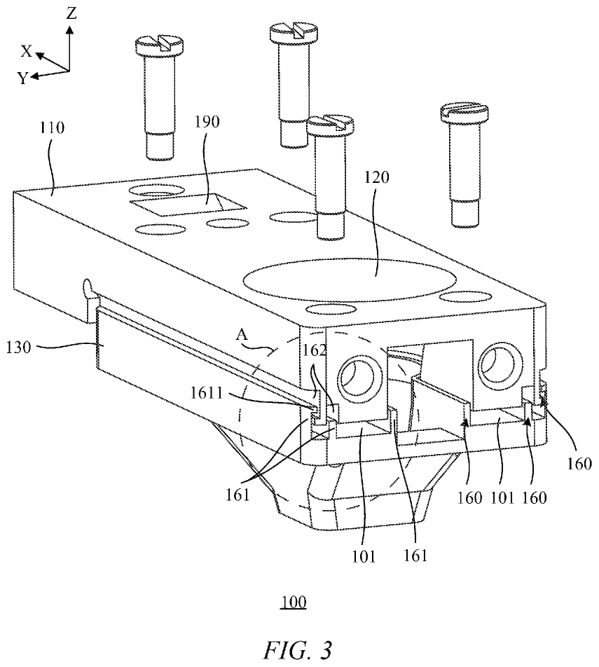

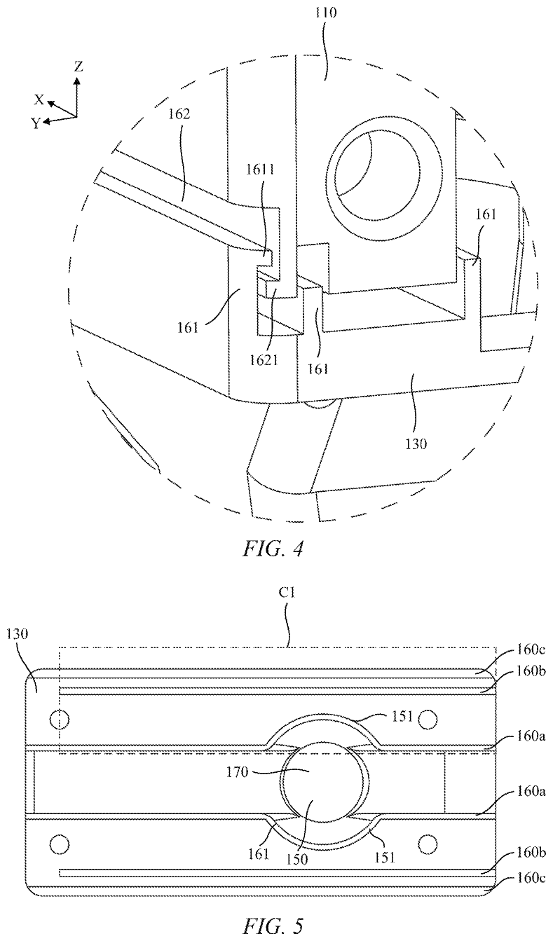

FIG. 1 is a schematic structural diagram of a welding press head tool according to an embodiment of the present application. FIG. 2 is a schematic exploded structural diagram of a welding press head tool according to an embodiment of the present application. FIG. 3 is a schematic structural diagram, from another perspective, of a welding press head tool according to an embodiment of the present application. FIG. 4 is a partially enlarged view of part A of FIG. 3. FIG. 5 is a top view of a press head in a welding press head tool according to an embodiment of the present application.

Referring to FIGS. 1 and 2, an embodiment of the present application provides a welding press head tool 200, including at least one press head assembly 100. Each press head assembly 100 includes:
a press plate 110 provided with a first through hole 120 penetrating the press plate 110 in a first direction;
a press head 130 movably connected to one side of the press plate 110 in the first direction Z and capable of having a first gap 101 with the press plate 110 when the press head moves relative to the press plate 110, where the press head 130 has a second through hole 150 penetrating the press head 130 in the first direction Z, and the first through hole 120 and the second through hole 150 are in communication to jointly define a welding channel 170 for providing a welding space; and at least two groups of blocking assemblies 160 arranged between the press plate 110 and the press head 130, where each blocking assembly 160 is used for blocking a channel formed by the first gap 101 in a second direction perpendicular to the first direction Z, and at least two groups of blocking assemblies 160 in all the blocking assemblies 160 are arranged spaced apart in a radial direction of the welding channel 170, and have overlapping portions in a circumferential direction of the welding channel 170.

There is the first gap 101 between the press plate 110 and the press head 130, such that the channel (hereinafter also referred to as an escape channel) for welding slag and laser light to escape is formed in the first gap 101 in the second direction perpendicular to the first direction Z, in other words, the welding slag in the welding channel 170 is radially spread or splashed to the outside of the welding press head tool 200 through the escape channel in the radial direction of the welding channel 170. In the above-described solution, the channel formed in the first gap 101 in the second direction may be blocked by arranging at least two groups of blocking assemblies 160 between the press plate 110 and the press head 130. In addition, the at least two groups of blocking assemblies 160 are arranged spaced apart in the radial direction of the welding channel 170 and have the overlapping portions in the circumferential direction of the welding channel 170, in other words, the at least two groups of blocking assemblies 160 are arranged spaced apart on the same side of the welding channel 170 in the radial direction, and the overlapping portion in the peripheral direction enables this region in the peripheral direction to have at least two barriers to block the splashed welding slag, effectively preventing the welding slag from being splashed to other non-welding parts on the battery cell, and reducing the maintenance cost of a welding device.

It can be understood that one or more press head assemblies 100 may be included in the welding press head tool 200. In the present application, two press head assemblies 100 being included in the welding press head tool 200 are described as an example, and the number of the press head assemblies 100 is similar in other cases, which will not be described in detail herein.

The press plate 110 may be connected to a rack of a welding device and be fixed relative to the rack. The press plate 110 is provided with a first through hole 120 penetrating the press plate 110 in the first direction Z, namely, the axial direction of the first through hole 120 is in the first direction Z.

In the embodiment of the present application, for convenience of explanation, the axial direction of the welding channel 170, namely, the axial direction of the first through hole 120, may be defined as the first direction Z, a direction X and a direction Y perpendicular to the first direction may be defined, and every two of the direction X, the direction Y and the first direction Z may be perpendicular to each other. The channel for the welding slag and the laser light to escape is formed in the first gap 101 in the second direction perpendicular to the first direction Z, where the second direction refers to any one direction in an XY plane. Thus, the escape channel is formed in the part of the region of the first gap 101 in the circumferential direction of the second through hole.

At least two groups of blocking assemblies 160 are arranged spaced apart on the same side of the radial direction of the welding channel 170, which means that at least two groups of blocking assemblies 160 are located on the same side of the welding channel 170 in a radius direction such that two or more blocking barriers are formed on the same side of the welding channel 170.

The press plate 110 and the press head 130 are movably connected to each other, which means that the relative positions of the press plate 110 and the press head 130 can be adjusted. The press head 130 is located on a side of the press plate 110 in the first direction Z, and when the press plate 110 moves relative to the press head 130, the first gap 101 is formed between the press plate 110 and the press head 130, and the first gap 101 becomes a channel for splashing the welding slag.

The blocking assemblies 160 may be arranged on the press plate 110 and/or the press head 130 to block the escape channel in the first gap 101.

In conjunction with FIGS. 2 and 5, at least two groups of blocking assemblies 160 are arranged spaced apart on the same side of the welding channel 170 in the radial direction and have the overlapping portions in the circumferential direction of the welding channel 170. Specifically, at least two groups of blocking assemblies 160 are arranged at different positions on the radial side of the welding channel 170, and at least two, or three, or more groups of blocking assemblies 160 should have overlapping portions in the circumferential direction of the welding channel 170.

For ease of illustration, the three groups of blocking assemblies 160 viewed from the upper side of a plane in FIG. 5 are respectively defined as first blocking assemblies 160a, second blocking assemblies 160b, and third blocking assemblies 160c. Illustratively, the first blocking assemblies 160a, the second blocking assemblies 160b, and the third blocking assemblies 160c are located at different positions in the radial direction of the welding channel 170, and the first blocking assemblies 160a, the second blocking assemblies 160b, and the third blocking assemblies 160c have overlapping regions Cl in the circumferential direction of the welding channel 170.

It can be understood that the embodiments of the present application are not limited thereto, it is also possible that only the second blocking assemblies 160b and the third blocking assemblies 160c have overlapping regions in the circumferential direction of the welding channel 170, or only the first blocking assemblies 160a and the second blocking assemblies 160b have overlapping regions in the circumferential direction of the welding channel 170, or only the first blocking assemblies 160a and the third blocking assemblies 160c have overlapping regions in the circumferential direction of the welding channel 170.

In some embodiments of the present application, referring to FIGS. 3 and 4, each blocking assembly 160 includes a blocking bar 161, and the blocking bar 161 is arranged on one of the press plate 110 and the press head 130 and extends out toward the other.

By arranging the strip-shaped blocking bars 161, on the one hand, machining is facilitated, and on the other hand, the blocking bars 161 can block the first gap 101 in the length direction thereof and have a good blocking effect. In the present application, the blocking bar 161 being arranged on the press head 130 is taken as an example for the following description, and is similar to the case where the blocking bar 161 is arranged on the press plate 110, which will not be described in detail herein.

In some embodiments of the present application, among the blocking assemblies 160 arranged spaced apart in the radial direction of the welding channel 170 and having the overlapping portions in the circumferential direction of the welding channel 170, at least one group of blocking assemblies 160 is located at an outer contour edge of the press head 130, and at least one group of blocking assemblies 160 is located between the outer contour edge of the press head 130 and an orifice edge 151 of the second through hole.

With regard to arrangement positions of the blocking assemblies 160, at least one group of blocking assemblies 160 is located at the outer contour edge of the press head 130, and can block the splashed welding slag at an outermost side of the press head 130, and can also prevent dust and the like outside the welding press head 130 from entering the welding press head 130; and at least one group of blocking assemblies 160 is located between the outer contour edge of the press head 130 and the orifice edge 151 of the second through hole, and can form two blocking lines for the first gap 101, so that the blocking effect on the welding slag is better.

Referring specifically to FIG. 5, the third blocking assemblies 160c are located at the outer contour edge of the press head 130, and the second blocking assemblies 160b are located between the outer contour edge of the press head 130 and the orifice edge 151 of the second through hole 150. In some other examples, the first blocking assemblies 160a are located at the orifice edge 151 of the second through hole 150.

With continued reference to FIGS. 3 and 4, in some embodiments of the present application, the blocking assembly 160 further includes an insert groove 162 corresponding to the blocking bar 161 and used for inserting the blocking bar 161; and the blocking bar 161 is arranged on one of the press plate 110 and the press head 130, and the insert groove 162 is formed in the other of the press plate 110 and the press head 130.

By arranging the insert grooves 162 capable of accommodating the blocking bars 161, when the press head 130 and the press plate 110 are close to each other, the blocking bars 161 on the press head 130 can extend into the corresponding insert grooves 162, such that on the one hand, the opposite surfaces of the press head 130 and the press plate 110 can continue to be close to each other, avoiding the phenomenon that the press head 130 cannot continue to move due to the arrangement of the blocking bars 161; on the other hand, the at least two groups of blocking bars 161 cooperate with the insert grooves 162 to form a structure similar to a labyrinth seal, so that a path for the welding slag or dust to pass in and out of the first gap 101 becomes longer, and the blocking effect is better.

In a specific implementation, when the blocking bar 161 is arranged on the press plate 110, the insert groove 162 is formed in the press head 130; and when the blocking bar 161 is arranged on the press head 130, the insert groove 162 is formed in the press plate 110.

In some embodiments of the present application, the description is provided by taking an example that in the same blocking assembly 160, the blocking bar 161 is arranged on the surface of the press head 130 facing the press plate 110, and the insert groove 162 is formed in the surface of the press plate 110 facing the press head 130. With regard to the case where the insert groove 162 is formed in the surface of the press head 130 facing the press plate 110, and the blocking bar 161 is arranged on the surface of the press plate 110 facing the press head 130, details are not described herein again.

It can be understood that during use of the welding press head 130, the press plate 110 needs to be connected to the rack of the welding device, and the press head 130 is movably connected to the press plate 110, making maintenance and replacement of the press head 130 easier compared with the press plate 110. If the blocking bar 161 structure is damaged or needs to be maintained or replaced in other cases, it is easier to arrange the blocking bar 161 structure on the press head 130.

In some embodiments of the present application, referring to FIG. 4, in a blocking assembly 160 located at the outer contour edge of the press head 130, a hooking portion 1611 is arranged at an extension end of the blocking bar 161, and a limiting portion 1621 is arranged at a rabbet of the insert groove 162 corresponding to the hooking portion 1611; and the hooking portion 1611 extends into the insert groove 162, and the hooking portion 1611 is used for being hooked on the limiting portion 1621 when the blocking bar moves away from the insert groove 162. In this case, by means of the cooperation of the hooking portion 1611 and the limiting portion 1621, a deviation movement of the press head 130 relative to the press plate 110 can be limited, that is to say, the phenomenon can be avoided that the press head 130 disengages from the press plate 110, causing the blocking assembly 160 to be incapable of blocking the first gap 101.

In a specific implementation, the hooking portion 1611 may be configured as a protrusion formed at the extension end of the blocking bar 161, and the limiting portion 1621 may be configured as a protrusion extending out from the rabbet of the insert groove 162 toward the blocking bar 161. Thus, when the blocking bar 161 moves relative to the insert groove 162 in a direction away from the insert groove 162, namely, in the first direction Z, the hooking portion 1611 and the limiting portion 1621 are limited and engage with each other to prevent the blocking bar 161 from moving away from the insert groove 162.

In some embodiments of the present application, as described above, among the blocking assemblies 160 arranged spaced apart in the radial direction of the welding channel 170 and having the overlapping portions in the circumferential direction of the welding channel 170, at least one group of blocking assemblies 160 is located at the orifice edge 151 of the second through hole. Specifically, the blocking assembly 160 being located at the orifice edge 151 of the second through hole actually means that the welding slag is blocked at a juncture of the first gap 101 and the second through hole 150, effectively preventing the welding slag from entering the first gap 101.

In specific implementations, referring to FIGS. 4 and 5, the blocking bar 161 in the first blocking assembly 160a may extend along the orifice edge 151 of the second through hole, so that the blocking effect on the welding slag is better.

In some embodiments of the present application, in the blocking assembly 160 located at the orifice edge 151 of the second through hole, the blocking bar 161 is arranged on the press head 130 and extends out to an inner side of an inner wall of the first through hole 120. Thus, the blocking bar 161 is capable of better blocking the first gap 101.

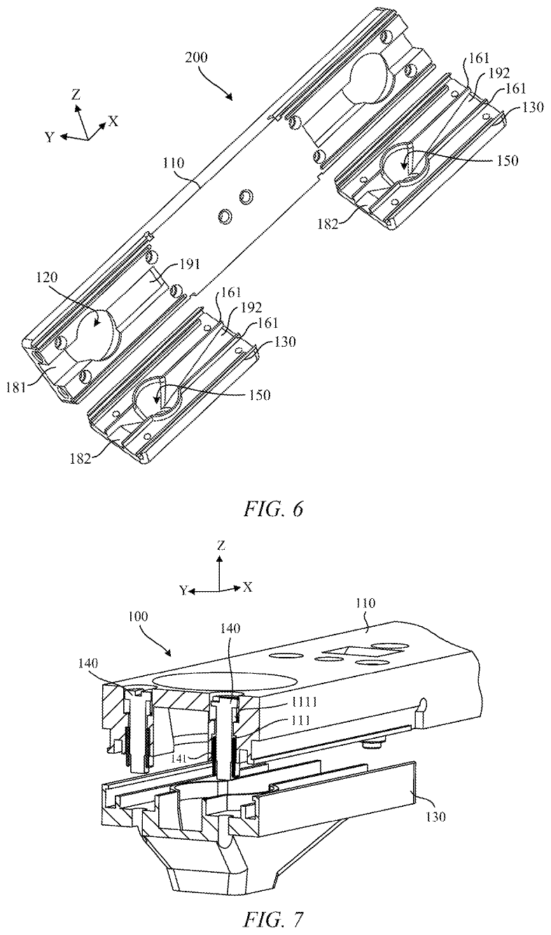

FIG. 6 is a schematic exploded structural diagram, from another perspective, of the welding press head tool 200 according to an embodiment of the present application. It should be noted that for ease of observation, the press plate 110 in FIG. 6 is shown after being rotated at an angle about the X direction.

Referring to FIGS. 1, 4 and 6, in some embodiments of the present application, a first recess 181 and a second recess 182 are respectively formed in the surfaces of the press plate 110 and the press head 130 opposite to each other, the first recess 181 is in communication with the first through hole 120, the second recess 182 is in communication with the second through hole 150, the first recess 181 and the second recess 182 correspond to each other in position and jointly define a dust removal channel 180 in communication with the outside of the press head assembly 100, and in the blocking assembly 160 located at the orifice edge 151 of the second through hole, part of the structure of the blocking bar 161 extends into an inner side of an inner wall of the first recess 181 and extends in an axial direction of the dust removal channel 180. In the above-described solution, one end of the dust removal channel 180 is in communication with the welding channel 170, and the other end may be connected to a negative pressure apparatus, such that the welding slag generated in the welding channel 170 can be removed through the dust removal channel 180. The dust removal channel 180 is formed by combining the first recess 181 and the second recess 182, and the blocking bar 161 in the blocking assembly 160 extends into the inner side of the inner wall of the first recess 181 and extends in the axial direction of the dust removal channel 180, so that the blocking bar 161 can better block the first gap 101.

Further, the blocking bar 161 may be continuously arranged at an edge of an opening of the second recess 182.

In some embodiments of the present application, with continued reference to FIGS. 1 and 6, a third recess 191 and a fourth recess 192 are respectively formed in the surfaces of the press plate 110 and the press head 130 opposite to each other, the third recess 191 is in communication with the first through hole 120, the fourth recess 192 is in communication with the second through hole 150, the third recess 191 and the fourth recess 192 correspond to each other in position and jointly define a gas intake channel 190 in communication with the outside of the press head assembly 100, and in the blocking assembly 160 located at the orifice edge 151 of the second through hole, the blocking bar 161 extends into the inner side of the inner wall of the first through hole 120 and extends in the axial direction of the gas intake channel 190.

One end of the gas intake channel 190 is in communication with a protective gas source, the other end is in communication with the welding channel 170, and the gas intake channel 190 is used for introducing a protective gas into the welding channel 170 during the welding, so as to prevent oxidation of a component to be welded during the welding. Similar to that described above, the gas intake channel 190 is formed by combining the third recess 191 and the fourth recess 192, and the blocking bar 161 in the blocking assembly 160 extends into an inner side of an inner wall of the third recess 191 and extends in the axial direction of the gas intake channel 190, so that the blocking bar 161 can better block the first gap 101.

Further, the blocking bar 161 may be continuously arranged at an edge of an opening of the fourth recess 192.

In an embodiment of the present application, it is also possible to make axial directions of the dust removal channel 180 and the gas intake channel 190 co-planar, namely, the dust removal channel 180 and the gas intake channel 190 are arranged opposite to each other.

In some embodiments of the present application, six groups of blocking assemblies 160 may be provided, where three groups of blocking assemblies 160 are located on a first side of the welding channel 170, are arranged spaced apart in the radial direction of the welding channel 170, and have overlapping portions in the circumferential direction of the welding channel 170; the other three groups of blocking assemblies 160 are located on a second side of the welding channel 170, are arranged spaced apart in the radial direction of the welding channel 170, and have overlapping portions in the circumferential direction of the welding channel 170;

where the first side and the second side are opposite sides of the welding channel 170 in the radial direction thereof. As described above, the welding slag is blocked at two opposite sides of the welding channel 170, so that the welding slag can be prevented from being splashed out of the welding channel 170 from two directions of the opposite sides of the welding channel 170.

In addition, the direction Y from the first side to the second side may be perpendicular to the opposite direction X of the gas intake channel 190 and the dust removal channel 180. Thus, the welding slag is blocked by the blocking bar 161 in the direction Y from the first side to the second side, and in the direction X perpendicular to the direction from the first side to the second side, there is no risk of slag splashing due to the presence of the gas intake channel 190 and the dust removal channel 180. This is because in the gas intake channel 190, the protective gas source is introduced into the welding channel 170, and an airflow is blown into the welding channel 170, so there is no fear that the welding slag will fly out from the gas intake channel 190; and in the dust removal channel 180, the welding slag is sucked from the welding channel 170 to the dust removal channel 180 due to the presence of a negative pressure.

In some embodiments of the present application, the blocking bars 161 in each blocking assembly 160 extend in the second direction; where the second direction is perpendicular to the direction Y from the first side to the second side and perpendicular to the first direction Z. In this way, the entire first gap 101 can be blocked as much as possible.

In addition, as described above, in some embodiments of the present application, at least two groups of press head assemblies 100 are provided, and the press plates 110 in the at least two groups of press head assemblies 100 are interconnected or integrally formed; and the press heads 130 in the at least two groups of press head assemblies 100 are located on the same side of the corresponding press plates 110 and are arranged spaced apart from each other. By interconnecting or integrally forming the press plates 110 in at least two groups of press head assemblies 100 as described above, the structure of the welding press head tool 200 can be more compact.

FIG. 7 is a cross-sectional view of a welding press head tool 200 according to an embodiment of the present application. FIG. 7 is a schematic diagram of the welding press head tool 200 cut along a YZ plane.

In some embodiments of the present application, referring to FIG. 7, the press head assembly 100 further includes a connecting rod 140, where the connecting rod 140 is movably connected to the press plate 110 in the first direction Z, and an end portion of the connecting rod 140 facing the press head 130 is detachably connected to the press head 130. The press head 130 is connected to the connecting rod 140, and the connecting rod 140 is movably connected to the press plate 110, such that when the connecting rod 140 moves relative to the press plate 110, the press head 130 can be driven to move relative to the press plate 110.

In a specific implementation, the connecting rod 140 may be a bolt, and a threaded end of the connecting rod 140 may be threadedly connected to the press head 130.

The press plate 110 may be provided with a guide hole 111 for the connecting rod 140 to penetrate, and the threaded end of the connecting rod 140 passes through the guide hole 111 from the side of the press plate 110 facing away from the press head 130 and is then threadedly connected to the press head 130. The connecting rod 140 and the guide hole 111 may be guide-fitted. The side of the guide hole 111 facing away from the press head 130 may be provided with a counter bored hole 1111, so that a head portion of the bolt may be located in the counter bored hole 1111 and a bottom wall portion of the counter bored hole 1111 may limit the head portion of the bolt.

In addition, in an embodiment of the present application, an elastic member 141 is further arranged between the press plate 110 and the press head 130, and the elastic member 141 is used to apply to the press head 130 an elastic force facing away from the press plate 110. Thus, when pressure is applied to an external apparatus press plate 110, the pressure can be applied to the press head 130 by means of the elastic member 141, and when there is fluctuation in a size of a component 330 to be welded, such fluctuation can be offset, so that the force applied by the press head 130 to the component 330 to be welded is a set value.

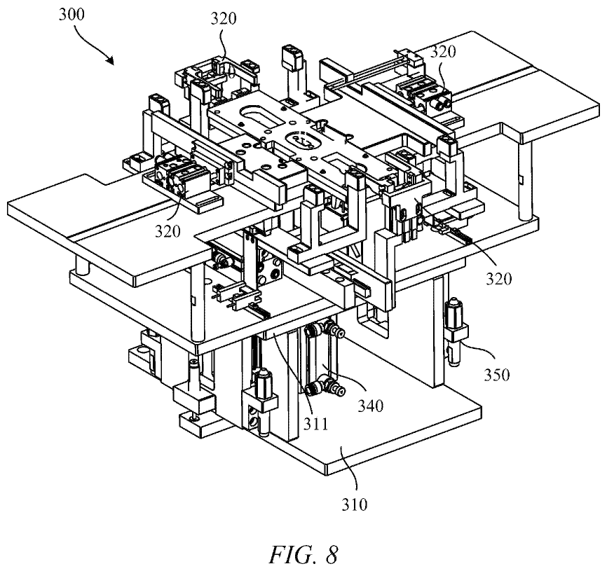

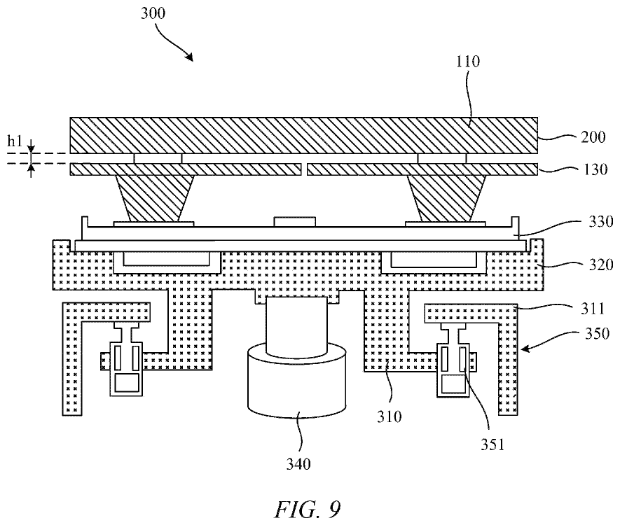

FIG. 8 is a schematic structural diagram of a welding device according to an embodiment of the present application, and FIG. 9 is a schematic diagram of an operating principle of a welding device according to an embodiment of the present application. It should be noted that in FIG. 8, a structure of the welding press head tool 200 is not shown.

Referring to FIGS. 8 and 9, some embodiments of the present application further provide a welding device 300. The welding device 300 includes a welding press head tool 200 in the foregoing embodiments. It can be understood that the structure, function, operating principle, etc. of the welding press head tool 200 have been described in detail in the foregoing embodiments and will not be described in detail herein.

In some embodiments of the present application, the welding device 300 further includes: a rack 310, a welding press head tool 200 being connected to the rack 310;
a clamp 320 that is used for clamping and fixing a component 330 to be welded and is arranged opposite to the welding press head tool 200;
a jacking mechanism 340 arranged on the rack 310, the jacking mechanism 340 being connected to the clamp 320 and used for driving the component 330 to be welded on the clamp 320 to move in an opposite direction of the welding press head tool 200 and the clamp 320;
a limiting mechanism 350 arranged on the rack 310, the limiting mechanism 350 being used for limiting, when the clamp 320 is located in a first preset position relative to the welding press head tool 200, a displacement of the clamp 320 toward the welding press head tool 200.

In a welding device of the related art, a component to be welded is clamped on a clamp, and a jacking mechanism is used for driving the clamp to move in a direction close to a welding press head, and after the clamp moves to a predetermined position, the welding press head presses against the component to be welded until the component to be welded is pressed between the welding press head and the clamp, and then a welding operation is performed. In this solution, there is often a problem that the welding quality of the component to be welded is not qualified due to instability of a clamping force of the welding press head and the clamp acting on the component to be welded.

In the above-described solution, a lower reference position of a welding operation is limited by arranging a limiting mechanism 350, so as to eliminate the instability of such a clamping force. Specifically, the limiting mechanism 350 is used for limiting, when the clamp 320 is located in the first preset position relative to the welding press head tool 200, the displacement of the clamp 320 toward the welding press head tool 200, namely, the jacking mechanism 340 can drive the clamp 320 to reach the same position each time, in other words, during welding each time, the component 330 to be welded on the welding clamp 320 can be located in the same position in a height direction. In this way, the component 330 to be welded has the same position lower reference in different welding processes, so that the problem can be solved that the clamping force is unstable due to fluctuations in the relative positions of the welding press head 130 and the clamp 320, and the welding quality is improved.

The clamp 320 can position the component 330 to be welded in four directions extending along a horizontal plane, and can also position a center spacing of the component 330 to be welded.

The jacking mechanism 340 may be a component capable of generating a linear displacement, such as a jacking cylinder. A cylinder body of the jacking cylinder may be connected to the rack 310, and a piston of the jacking cylinder may be connected to the clamp 320 and drive the clamp 320 to move toward the welding press head 130. In addition, the first preset position herein may be determined according to actual needs.

In some embodiments of the present application, the limiting mechanism 350 includes a moving member 351 and a limiting baffle 311, where the moving member 351 is connected to the clamp 320; the limiting baffle 311 is arranged on the rack 310, and the limiting baffle 311 is located on a movement path of the moving member 351; and when the moving member 351 moves to abut against the limiting baffle 311 under the drive of the clamp 320, the clamp 320 is located in the first preset position (the position as shown in FIG. 9) relative to the welding press head tool 200.

In the above-described solution, the moving member 351 can be in linkage with the clamp 320, and a position of the moving member 351 is limited by means of the limiting baffle 311, so that the position of the clamp 320 is limited. The structure is simple and easy to operate.

In the embodiment of the present application, with reference to FIGS. 7 and 9, as described above, the elastic member 141 is arranged between the press plate 110 and the press head 130, and the elastic member 141 is used for applying to the press head 130 an elastic force facing away from the press plate 110. During the actual welding, the size of the component 330 to be welded that is pressed between the welding press head 130 and the clamp 320 may fluctuate, which may also cause variation in the pressing force applied to the component 330 to be welded, resulting in instability of the welding quality and an increase in the probability of defective products.

Also, by arranging the elastic member 141 between the press plate 110 and the press head 130, the elastic force applied by the press plate 110 is transferred to the press head 130 by means of the elastic member 141 and transferred to the component 330 to be welded, and the elastic member 141 elastically deforms in the opposite direction of the press plate 110 and the press head 130, so that the fluctuation of the size of the component 330 to be welded can be offset. Also, the welding press head assembly 100 can be prevented from crushing the component 330 to be welded.

In an embodiment of the present application, as shown in FIG. 9, the gap hl between the press plate 110 and the press head 130 is greater than or equal to 2 mm. In an actual welding process, the applicant of the present application found after research that the dimensional chain tolerance of the component 330 to be welded is less than 2 mm, so long as the gap hl between the press plate 110 and the press head 130 (the gap between the press plate 110 and the press head 130 when the press head 130 does not abut against the component 330 to be welded) is greater than or equal to 2 mm, and the elastic member 141 can be allowed to offset the dimensional chain tolerance of the component 330 to be welded. Even for different tolerances of components 330 to be welded, the component 330 to be welded can be subjected to the same pressure.

In an embodiment of the present application, the elastic member 141 may have an elastic coefficient of 5.9 N/mm. In combination with the above-mentioned gap hl between the press plate 110 and the press head 130 being greater than or equal to 2 mm, it is possible to control the pressing force of the welding press head tool 200 acting on the component to be welded to be less than or equal to 150 N. Furthermore, the elastic member 141 may be a spring.

The various technical features of the above embodiments can be combined in any manner, and in order to simplify the description, not all possible combinations of the various technical features of the above embodiments are described. However, as long as there is no conflict between the combinations of these technical features, they should be considered to be within the scope of the description in this application.

The foregoing embodiments merely illustrate several implementations of the present application, and the description thereof is relatively specific and detailed, but it should not be construed as a limitation on the patent scope of the present utility model. It should be pointed out that those of ordinary skill in the art may also make several variations and improvements without departing from the concept of the present application. All these variations and improvements fall within the scope of protection of the present application. Therefore, the scope of protection of the present application shall be subject to the appended claims.

1. A welding press head tool, comprising at least one press head assembly, each press head assembly comprising:
a press plate provided with a first through hole penetrating the press plate in a first direction;
a press head movably connected to one side of the press plate in the first direction and capable of having a first gap with the press plate when the press head moves relative to the press plate, the press head having a second through hole penetrating the press head in the first direction, and the first through hole and the second through hole being in communication to jointly define a welding channel for providing a welding space; and
at least two groups of blocking assemblies arranged between the press plate and the press head, each of the blocking assemblies being used for blocking a channel formed by the first gap in a second direction perpendicular to the first direction, and at least two groups of the blocking assemblies in all the blocking assemblies being arranged spaced apart in a radial direction of the welding channel and having overlapping portions in a circumferential direction of the welding channel.

2. The welding press head tool according to claim 1, wherein each of the blocking assemblies comprises a blocking bar, and the blocking bar is arranged on one of the press plate and the press head and extends out toward the other.

3. The welding press head tool according to claim 2, wherein among the blocking assemblies arranged spaced apart in the radial direction of the welding channel and having the overlapping portions in the circumferential direction of the welding channel, at least one group of the blocking assemblies is located at an outer contour edge of the press head, and at least one group of the blocking assemblies is located between the outer contour edge of the press head and an orifice edge of the second through hole.

4. The welding press head tool according to claim 3, wherein the blocking assembly further comprises an insert groove arranged corresponding to the blocking bar and used for inserting the blocking bar;
if the blocking bar is arranged on the press plate, the insert groove is formed in the press head; and
if the blocking bar is arranged on the press head, the insert groove is formed in the press plate.

5. The welding press head tool according to claim 4, wherein in the same blocking assembly, the blocking bar is arranged on a surface of the press head facing the press plate, and the insert groove is formed in a surface of the press plate facing the press head.

6. The welding press head tool according to claim 4, wherein in the blocking assembly located at the outer contour edge of the press head, a hooking portion is arranged at an extension end of the blocking bar, and a limiting portion is arranged at a rabbet of the insert groove corresponding to the hooking portion; and
the hooking portion extends into the insert groove,
and the hooking portion is used for being hooked on the limiting portion when the blocking bar moves away from the insert groove.

7. The welding press head tool according to claim 2, wherein among the blocking assemblies arranged spaced apart in the radial direction of the welding channel and having the overlapping portions in the circumferential direction of the welding channel, at least one group of the blocking assemblies is located at the orifice edge of the second through hole.

8. The welding press head tool according to claim 7, wherein in the blocking assembly located at the orifice edge of the second through hole, the blocking bar is arranged on the press head and extends out to an inner side of an inner wall of the first through hole.

9. The welding press head tool according to claim 8, wherein a first recess and a second recess are respectively formed in surfaces of the press plate and the press head opposite to each other, the first recess is in communication with the first through hole, the second recess is in communication with the second through hole, the first recess and the second recess correspond to each other in position and jointly define a dust removal channel in communication with the outside of the press head assembly, and in the blocking assembly located at the orifice edge of the second through hole, part of a structure of the blocking bar extends into an inner side of an inner wall of the first recess and extends in an axial direction of the dust removal channel.

10. The welding press head tool according to claim 9, wherein a third recess and a fourth recess are respectively formed in surfaces of the press plate and the press head opposite to each other, the third recess is in communication with the first through hole, the fourth recess is in communication with the second through hole, the third recess and the fourth recess correspond to each other in position and jointly define a gas intake channel in communication with the outside of the press head assembly, and in the blocking assembly at the orifice edge of the second through hole, the blocking bar extends into an inner side of an inner wall of the third recess and extends in an axial direction of the gas intake channel.

11. The welding press head tool according to claim 2, wherein six groups of the blocking assemblies are provided, wherein three groups of the blocking assemblies are located on a first side of the welding channel, are arranged spaced apart in the radial direction of the welding channel, and have overlapping portions in the circumferential direction of the welding channel;
the other three groups of the blocking assemblies are located on a second side of the welding channel, are arranged spaced apart in the radial direction of the welding channel, and have overlapping portions in the circumferential direction of the welding channel;
wherein the first side and the second side are opposite sides of the welding channel in the radial direction thereof.

12. The welding press head tool according to claim 11, wherein the blocking bar in each of the blocking assemblies extends in a second direction;
wherein the second direction is perpendicular to a direction from the first side to the second side and perpendicular to the first direction.

13. The welding press head tool according to claim 1, wherein at least two groups of the press head assemblies are provided, and the press plates in the at least two groups of press head assemblies are interconnected or integrally formed; and
the press heads in the at least two groups of the press head assemblies are located on the same side of the corresponding press plate and are spaced apart from each other.

14. The welding press head tool according to claim 1, wherein the press head assembly further includes a connecting rod, and the connecting rod is movably connected to the press plate in the first direction, and an end portion of the connecting rod facing the press head is detachably connected to the press head.

15. A welding device, comprising the welding press head tool of claim 1.

16. The welding device according to claim 15, wherein the welding device further comprises:
a rack, the welding press head tool being connected to the rack;
a clamp for clamping and fixing a component to be welded, and arranged opposite to the welding press head tool;
a jacking mechanism arranged on the rack, the jacking mechanism being connected to the clamp and used for driving the component to be welded on the clamp to move in an opposite direction of the welding press head tool and the clamp; and
a limiting mechanism arranged on the rack, the limiting mechanism being used for limiting, when the clamp is located at a first preset position relative to the welding press head tool, a displacement of the clamp toward the welding press head tool.

17. The welding device according to claim 16, wherein the limiting mechanism comprises a moving member and a limiting baffle, wherein the moving member is connected to the clamp;
the limiting baffle is connected to the rack, and the limiting baffle is located on a movement path of the moving member; and
when the moving member moves to abut against the limiting baffle under the drive of the clamp, the clamp is located in the first preset position relative to the welding press head tool.

18. The welding device according to claim 15, wherein the press plate and the press head are movably connected by means of a connecting rod, an elastic member is arranged between the press plate and the press head, and the elastic member is used for applying to the press head an elastic force facing away from the press plate; and
a first gap between the press plate and the press head is greater than or equal to 2 mm.

19. The welding device according to claim 18, wherein the elastic member has an elastic coefficient of 5.9 N/mm.
